(19) United States
(12) Patent Application Publication
(10) Pub. No.: US 2013/0068368 A1
(43) Pub. Date: Mar. 21, 2013

(54) APPARATUS FOR TESTING ORGANIC LIGHT-EMITTING DISPLAY APPARATUS, AND SYSTEM FOR MANUFACTURING ORGANIC LIGHT-EMITTING DISPLAY APPARATUS BY USING THE SAME

(71) Applicants: Sung-Kook KIM, Yongin-City (KR); Kyoung-Ho Yang, Yongin-City (KR); Jin-Ho Choi, Yongin-City (KR); Sang-Hyuk Kwon, Yongin-City (KR); Yong-Shin Cho, Yongin-City (KR)

(72) Inventors: Sung-Kook KIM, Yongin-City (KR); Kyoung-Ho Yang, Yongin-City (KR); Jin-Ho Choi, Yongin-City (KR); Sang-Hyuk Kwon, Yongin-City (KR); Yong-Shin Cho, Yongin-City (KR)

(21) Appl. No.: 13/592,679

(22) Filed: Aug. 23, 2012

(30) Foreign Application Priority Data
Sep. 16, 2011 (KR) 10-2011-0093640

(51) Int. Cl. G01N 21/01; H05B 33/10; G01B 11/26

(52) U.S. Cl. 156/64; 356/244; 356/138; 156/378

(57) ABSTRACT

A testing apparatus for testing an organic light-emitting display apparatus including: a test chamber for retaining a first substrate having a plurality of exposed cells, each cell including an organic emission unit; a stage in the test chamber, the stage configured to support the first substrate; a plurality of probe bars, each of the probe bars including a plurality of probe blocks for respectively contacting the exposed plurality of cells of the first substrate to supply an external signal to the exposed plurality of cells; a probe bar moving unit coupled to the probe bar; and a probe bar supply unit including the plurality of probe bars, wherein the probe bar moving unit is configured to move a probe bar to and from the stage and to and from the supply unit to obtain and unload a probe bar.

### CROSS-REFERENCE TO RELATED PATENT APPLICATION

This application claims the benefit of Korean Patent Application No. 10-2011-0093640, filed on Sep. 16, 2011, in the Korean Intellectual Property Office, the disclosure of which is incorporated herein in its entirety by reference.

### BACKGROUND

1. Field

One or more aspects of the embodiments relate to an apparatus for testing an organic light-emitting display apparatus and a system for manufacturing an organic light-emitting display apparatus by using the same.

2. Description of the Related Art

Recently, display apparatuses have been replaced with thin flat panel display apparatuses which are handy to carry. From among flat panel display apparatuses, electroluminescent display apparatuses are self-emitting display apparatuses that have a larger viewing angle, better contrast characteristics, and a faster response rate than other flat panel display apparatuses. Thus, electroluminescent display apparatuses have drawn attention as next-generation display devices. In particular, an organic light-emitting display apparatus, which includes an emission layer formed of an organic material, has better brightness, a lower driving voltage, and a faster response rate, and can provide multi-color images, compared to an inorganic light-emitting display apparatus.

The organic light-emitting display apparatus may include a thin film transistor (TFT), and an organic light-emitting device that is driven by the TFT to generate light. The organic light-emitting device may basically have a structure in which an anode layer, an organic layer, and a cathode layer are sequentially stacked in the order stated. Thus, if the TFT is driven to apply a voltage between the anode layer and the cathode layer included in the organic light-emitting device, then an appropriate electric potential is generated by the organic layer. Thus, light may be generated in an emission layer included in the organic layer.

The organic light-emitting display device may be very sensitive to moisture, oxygen, light, and the like. Thus, when the organic light-emitting display device contacts moisture, oxygen, or light, it is likely to deteriorate. If oxygen, moisture, or the like is diffused into the organic layer, then electrochemical moving of electric charges occurs to form an oxide at an interface between an electrode and the organic layer. The oxide separates the organic layer from a pixel electrode or an opposite electrode, thus causing, for example, dark spots. Thus, the lifetime of the organic light-emitting display device decreases. Accordingly, sealing technology is generally used to protect the organic light-emitting display device against external moisture, oxygen, light, or the like. In general, an organic light-emitting display device is formed on a substrate, and an encapsulating substrate is then disposed on the substrate to cover the organic light-emitting display device.

A test, e.g., an image quality test, is conducted on an organic light-emitting display apparatus before the organic light-emitting display apparatus is placed on the market. In general, after an encapsulating process is performed, the organic light-emitting display apparatus is moved to a different location and for example, the image quality test is performed on the organic light-emitting display apparatus.

### SUMMARY

One or more embodiments may provide a testing apparatus for testing an organic light-emitting display apparatus, including: a test chamber for retaining a first substrate having a plurality of exposed cells, each cell including an organic emission unit; a stage in the test chamber, the stage configured to support the first substrate; a plurality of probe bars, each of the probe bars including a plurality of probe blocks for respectively contacting the exposed plurality of cells of the first substrate to supply an external signal to the exposed plurality of cells; a probe bar moving unit coupled to the probe bar; and a probe bar supply unit including the plurality of probe bars, wherein the probe bar moving unit is configured to move a probe bar to and from the stage and to and from the probe bar supply unit to obtain and unload a probe bar. The stage may be rotatable with respect to an axis normal to a support surface of the stage. The stage may fix the first substrate in a non-contact manner.

A support unit may be disposed in the test chamber, wherein the stage, the probe bar moving unit, and the probe bar supply unit may be disposed on a surface of the support unit. The support unit may be rotatable with respect to an axis parallel with the surface of the support unit. The support unit may further include a supporting frame on which the stage is disposed, the probe bar moving unit and the probe bar supply unit being disposed on one surface of the supporting frame; and supporting legs rotatably connected to opposing sides of the supporting frame.

The testing apparatus may further include an alignment unit for aligning the first substrate and the plurality of probe bars with each other.

The probe bar moving unit may include an alignment camera for photographing an alignment mark on the exposed plurality of cells; and alignment units for moving the probe bar moving unit and aligning at least one of the plurality of probe bars with the first substrate, based on an image captured by the alignment camera.

The testing apparatus may further include a guide unit for guiding the moving of the probe bar moving unit.

The probe bar supply unit may provide the probe bar moving unit with a probe bar from among the plurality of probe bars, the probe bar being suitable for a type of the plurality of cells.

The probe bar supply unit may have a polygonal pillar shape. The plurality of probe bars may be respectively disposed on a plurality of surfaces of the probe bar supply unit.

The probe bar supply unit may include different types of the plurality of probe bars, and provide the probe bar moving unit with a probe bar corresponding to a type of the first substrate loaded into the test chamber.

The probe bar moving unit may include a connector being electrically connected to the plurality of probe bars; and a clamp for securing the plurality of probe bars.

The testing apparatus may further include an optical test unit disposed on the test chamber, the optical test unit for testing driving states of the plurality of cells.

The optical test unit may include an auto vision camera for performing an image quality test on the plurality of cells; a property tester for performing an optical property test on the plurality of cells; a first linear guide for guiding the auto vision camera and the property tester to move in a first direction; and a second linear guide for guiding the first linear guide to move in a second direction perpendicular to the first direction.

The test chamber may include a gate through which the first substrate may enter and exit the test chamber; a first transmission unit for allowing an observer outside the test chamber to observe the first substrate loaded into the test chamber; and a second transmission unit for allowing the optical test unit to observe the first substrate loaded into the test chamber.

The test chamber may be in an N₂ atmosphere.

One or more embodiments may provide a system for manufacturing an organic light-emitting display apparatus, the system including a deposition chamber for forming a plurality of cells on a first substrate, each of the plurality of cells including an organic emission unit; a bonding device for sealing a second substrate on the first substrate to cover the plurality of cells; and a testing apparatus for testing the plurality of cells on the first substrate before the first substrate and the second substrate are sealed. The testing apparatus may include a test chamber in which the first substrate is loaded into or is unloaded from; a stage in the test chamber, the first substrate being secured to the stage when loaded into the test chamber; a plurality of probe bars each including a plurality of probe blocks for respectively contacting the plurality of cells to supply an external signal to the plurality of cells; a probe bar moving unit combined with the probe bar, the probe bar moving unit for moving a probe bar with respect to the stage; and a probe bar supply unit including the plurality of probe bars. The probe bar moving unit may be moved to the probe bar supply unit to exchange a probe bar with one of the plurality of probe bars.

The deposition chamber may be in a vacuum state, and the bonding device and the testing apparatus may be in an N₂ atmosphere.

The stage may be rotatable with respect to an axis normal to a support surface of the stage.

The stage may fix the first substrate in a non-contact manner.

The system may further include a support unit disposed in the test chamber, wherein the stage, the probe bar moving unit, and the probe bar supply unit are disposed on a surface of the support unit.

The support unit may be rotatable with respect to an axis parallel with the surface of the support unit.

The support unit may include a supporting frame on which the stage is disposed, the probe bar moving unit, and the probe bar supply unit being disposed on one surface of the supporting frame; and supporting legs may be rotatably connected to opposing sides of the supporting frame.

The system may further include an alignment unit for aligning the first substrate and the plurality of probe bars with each other.

The probe bar moving unit may include an alignment camera for photographing an alignment mark on the first substrate and the plurality of cells; and alignment units for moving the probe bar moving and aligning at least one of the plurality of probe bars with the first substrate based on an image captured by the alignment camera.

The system may further include a guide unit for guiding the moving of the probe bar moving unit. The probe bar supply unit may provide the probe bar moving unit with a probe bar from among the plurality of probe bars, the probe bar being suitable for a type of the plurality of cells.

The probe bar supply unit may have a polygonal pillar shape. The plurality of probe bars may be respectively disposed on a plurality of surfaces of the probe bar supply unit.

The probe bar supply unit may include different types of the plurality of probe bars, and provide the probe bar moving unit with a probe bar corresponding to a type of the first substrate loaded into the test chamber from among the plurality of probe bars.

The probe bar moving unit may include a connector being electrically connected to the plurality of probe bars; and a clamp for fixing the plurality of probe bars.

The system may further include an optical test unit disposed on the test chamber, the optical test unit for testing driving states of the plurality of cells.

The optical test unit may include an auto vision camera for performing an image quality test on the plurality of cells; a property tester for performing an optical property test on the plurality of cells; a first linear guide for guiding the auto vision camera and the property tester to move in a first direction; and a second linear guide for guiding the first linear guide to move in a second direction perpendicular to the first direction.

The test chamber may include a gate through which the first substrate may enter and exit the test chamber; a first transmission unit for allowing an observer outside the test chamber to observe the first substrate loaded into the test chamber; and a second transmission unit for allowing the optical test unit to observe the first substrate loaded into the test chamber. A process chamber may be disposed between the deposition chamber and the bonding device.

One or more embodiments may provide a method for manufacturing an organic light-emitting display apparatus, including: forming a plurality of cells on a first substrate in a deposition chamber, each cell including an organic emission unit; passing the first substrate from the deposition chamber through a bonding device; loading the first substrate into a testing apparatus to test the plurality of cells on the first substrate; and moving the first substrate from the testing apparatus to the bonding device to seal a second substrate on the first substrate to cover the plurality of cells.

### BRIEF DESCRIPTION OF THE DRAWINGS

The above and other features and advantages of the embodiments will become more apparent by describing in detail exemplary embodiments thereof with reference to the attached drawings in which:

FIG. 1 illustrates a perspective view of a testing apparatus for testing an organic light-emitting display apparatus, according to an embodiment;

FIG. 2 illustrates a cross-sectional view of the testing apparatus illustrated in

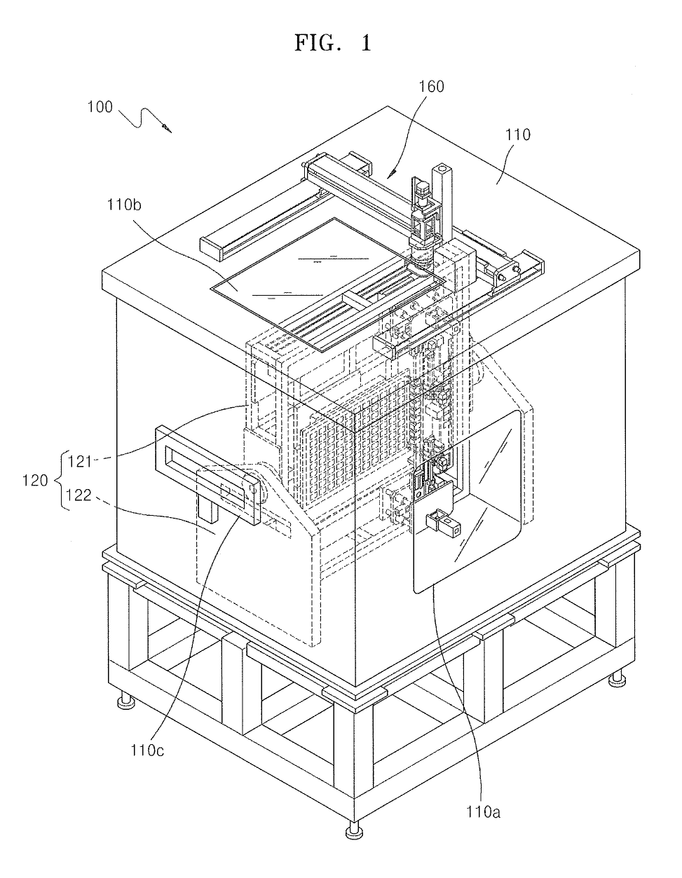

FIG. 1;

FIG. 3 illustrates a perspective view of a test chamber illustrated in FIG. 1;

FIGS. 4 to 6 illustrate perspective views of various operating states of a support unit included in the testing apparatus of FIG. 1, according to an embodiment;

FIG. 7 illustrates a perspective view of a probe bar moving unit included in the testing apparatus of FIG. 1, according to an embodiment;

FIG. 8 illustrates a bottom perspective view of the probe bar moving unit of FIG. 7;

FIG. 9 illustrates a perspective view of a probe bar supply unit of the testing apparatus of FIG. 1, according to an embodiment;

FIG. 10 illustrates a perspective view of an optical test unit of the testing apparatus of FIG. 1, according to an embodiment;

FIG. 11 illustrates a perspective view of a first substrate having a plurality of cells on a surface thereof and a second substrate disposed on the first substrate, according to an embodiment;

FIG. 12 illustrates a schematic cross-sectional view of one of the plurality of cells of FIG. 11, according to an embodiment; and

FIG. 13 illustrates a schematic diagram of a system for manufacturing an organic light-emitting display apparatus, according to an embodiment.

### DETAILED DESCRIPTION

Hereinafter, exemplary embodiments will be described with reference to the accompanying drawings.

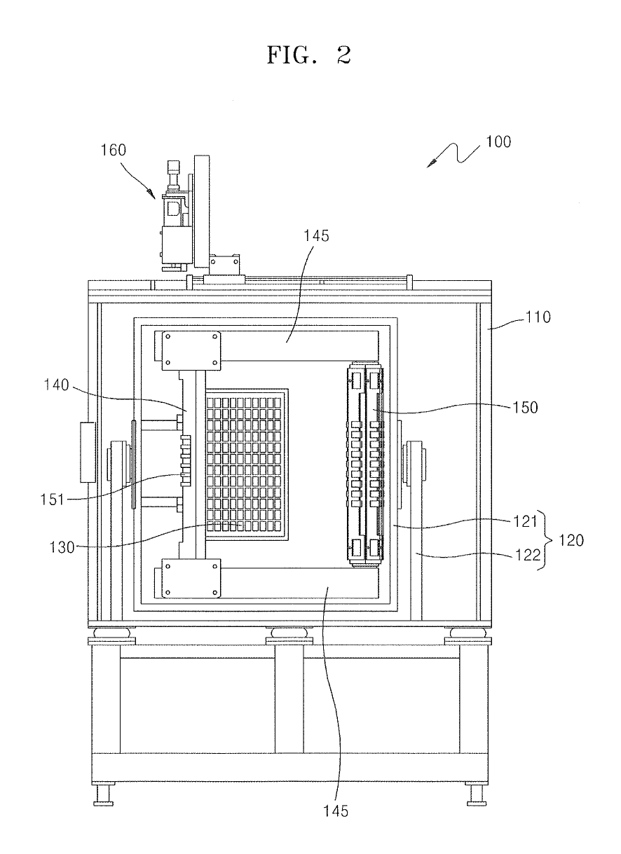

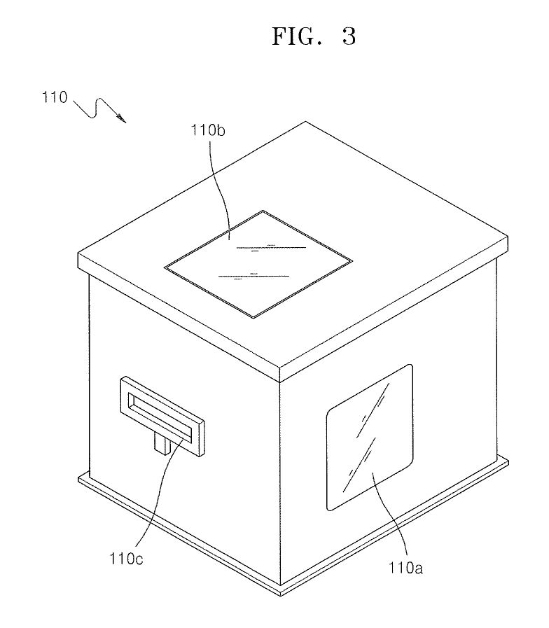

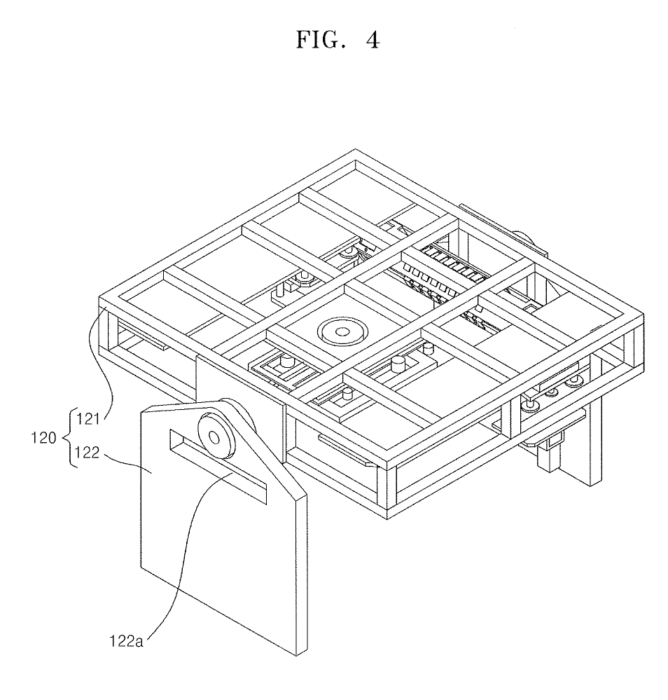

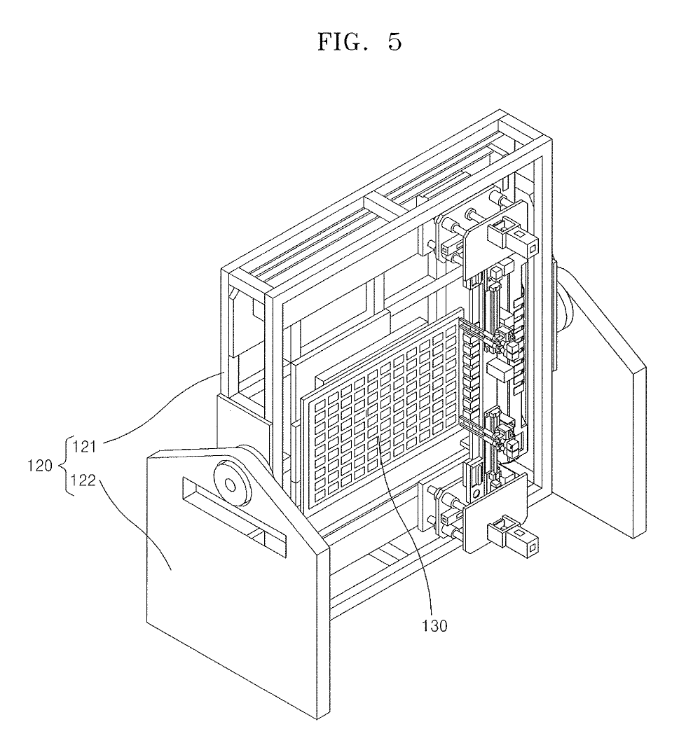

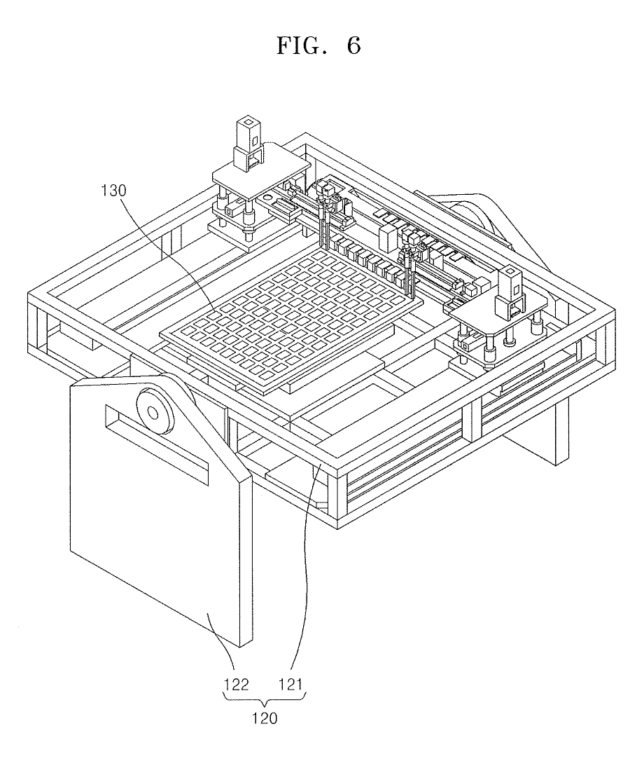

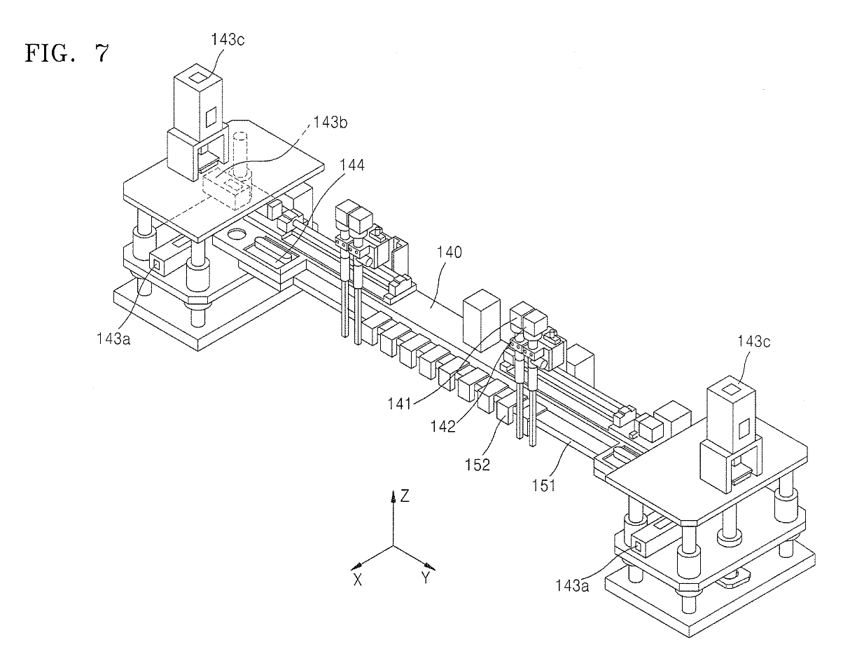

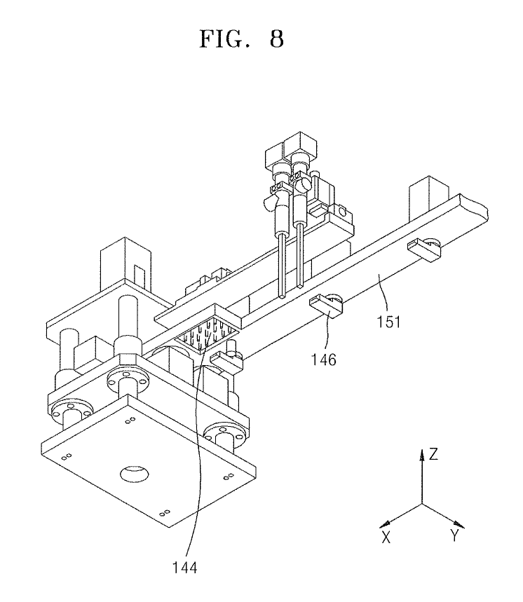

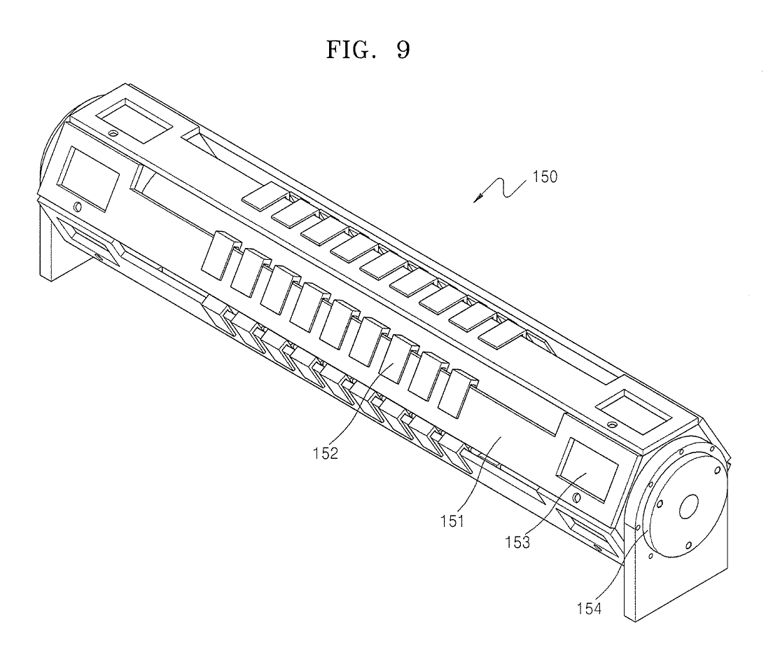

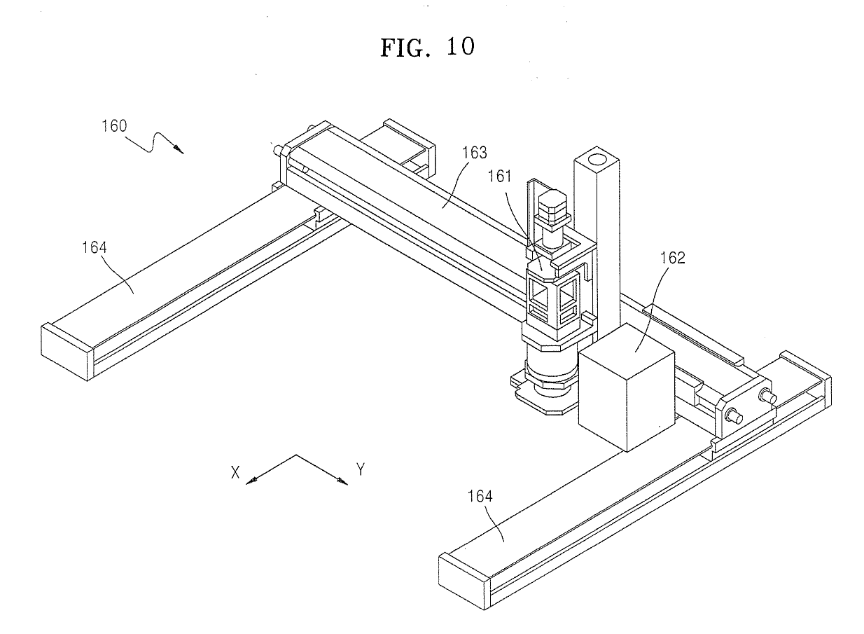

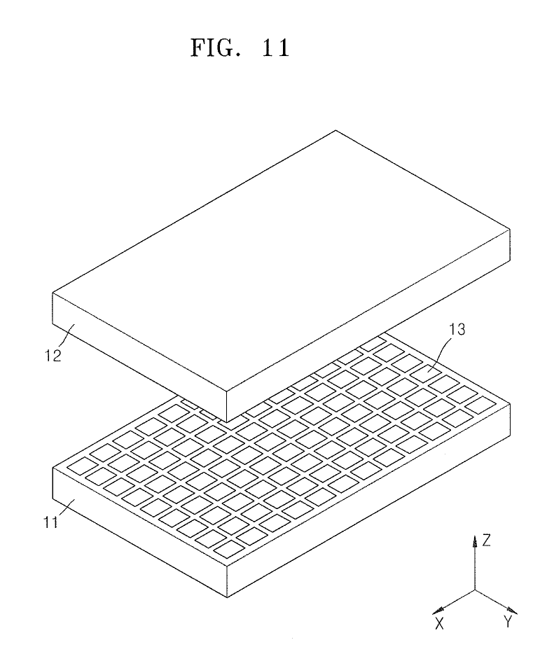

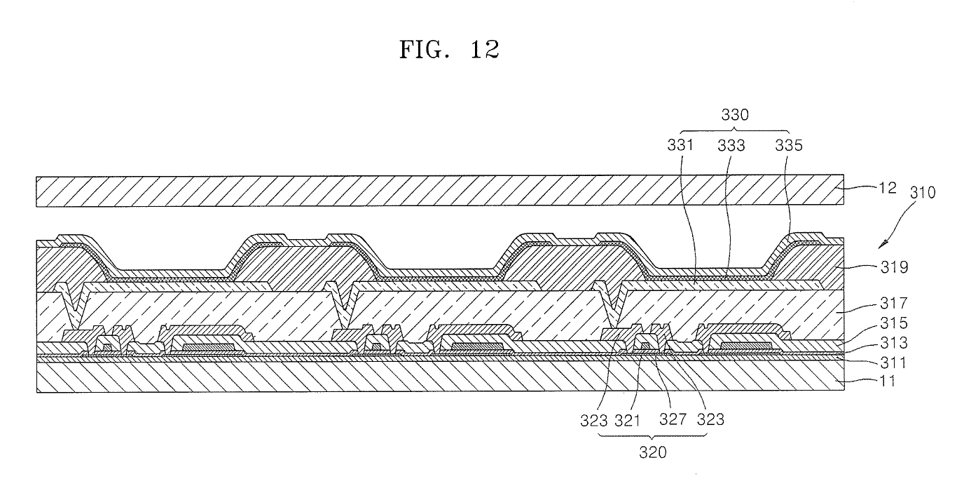

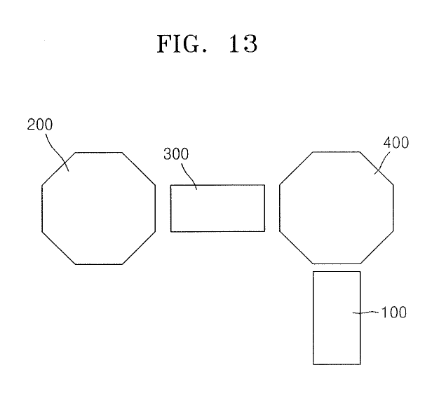

FIG. 1 illustrates a perspective view of a testing apparatus 100 for testing an organic light-emitting display apparatus, according to an embodiment. FIG. 2 illustrates a cross-sectional view of the testing apparatus 100 illustrated in FIG. 1.

Referring to FIGS. 1 and 2, the testing apparatus 100 may include a test chamber 110, a support unit 120, a stage 130, a probe bar moving unit 140, a probe bar 151, a probe bar supply unit 150, and an optical test unit 160.

A plurality of cells 13 (FIG. 11) may be formed on a first substrate (mother substrate) 11 of FIG. 11. Before a second substrate 12 (FIG. 11) may be sealed onto the first substrate 11, the first substrate 11 may be loaded into the test chamber 110 in the testing apparatus 100 to test, for example, driving states of the plurality of cells 13. Since the plurality of cells 13 on the first substrate 11 may be tested before the second substrate 12 is sealed onto the first substrate 11, i.e., the plurality of cells 13 are exposed, mother conductive lines may not be needed to conduct the test. Thus, more cells 13 may be formed on the first substrate 11. The testing apparatus 100, according to an embodiment, may be connected to a bonding device 400 (FIG. 13) for sealing the second substrate 12 onto the first substrate 11. Thus, deposition, testing, and bonding processes may be continuously performed, thereby shortening a production line and improving productivity, as will be described below.

Referring back to FIGS. 1 and 2, the test chamber 110 may provide a space in which the first substrate 11 may be loaded and tested, and from which the first substrate 11 may be unloaded. The support unit 120, the stage 130, the probe bar moving unit 140, the probe bar 151, and the probe bar supply unit 150 may be disposed in the test chamber 110. The optical test unit 160 may be disposed on the test chamber 110.

FIG. 3 illustrates a perspective view of the test chamber 110 in FIG. 1. Referring to FIG. 3, the test chamber 110 may include a first transmission unit 110a, a second transmission unit 110b, and a gate 110c. The test chamber may be in an N₂ atmosphere.

The first transmission unit 110a may include a window through which an observer outside the test chamber 110 may observe the first substrate 11 under test in the test chamber 110. The second transmission unit 110b may include a window through which the optical test unit 160 on the test chamber 110 observes the first substrate 11 in the test chamber 110. The support unit 120, on which the stage 130 may be placed, may be rotatable. The support unit 120 may be rotated toward the first transmission unit 110a so that an external observer may view the first substrate 11 through the first transmission unit 110a. Also, the support unit 120 may be rotated toward the second transmission unit 110b so that the optical test unit 160 may test the first substrate 11.

The gate 110c may be a mouth through which the first substrate 11 may be loaded into and unloaded from the test chamber 110. Referring to FIG. 13, the testing apparatus 100 may be connected to the bonding device 400. The plurality of cells 13 (FIG. 11) may be formed on the first substrate 11 in a deposition chamber 200. Afterwards, the first substrate 11 may sequentially pass through a process chamber 300 and the bonding device 400, and may then be loaded into the testing apparatus 100. In the testing apparatus 100, the gate 110c (FIG. 3) may face the bonding device 400. The first substrate 11 may be moved from the bonding device 400 to the testing apparatus 100 or from the testing apparatus 100 to the bonding device 400 through the gate 110c.

Referring to FIG. 2, the support unit 120 may include a supporting frame 121 and supporting legs 122. The stage 130, the probe bar moving unit 140, and the probe bar supply unit 150 may be disposed on one surface of the supporting frame 121.

The supporting legs 122 may be respectively connected to opposing sides of the supporting frame 121. The supporting frame 121 may be rotated with respect to portions of the supporting legs 122 that are connected to the supporting frame 121 as central axes L. The supporting frame 121 may be rotated to change a location of the first substrate 11 so that an observer outside the test chamber 110 may observe the first substrate 11 or so that the optical test unit 160 may observe the first substrate 11, once the first substrate 11 is loaded into or unloaded from the testing apparatus 100.

FIGS. 4 to 6 illustrate perspective views of various operating states of the supporting unit 120 included in the testing apparatus 100 of FIG. 1, according to an embodiment.

Specifically, FIG. 4 illustrates the location of the supporting frame 121 when the first substrate 11 is loaded into or unloaded from the test chamber 110. Referring to FIG. 4, the supporting frame 121 may be disposed in such a manner that one surface thereof may be positioned to be parallel with the ground or horizontal support surface upon which the testing apparatus 100 rests. Thus, when a horizontal deposition process is performed in the deposition chamber 200 (FIG. 13), the first substrate 11 may sequentially pass through the process chamber 300 (FIG. 13) and the bonding device 400 (FIG. 13). The first substrate 11 may then loaded into the testing apparatus 100 without tilting the first substrate 11 itself, i.e., while maintaining a surface of the first substrate 11 parallel with the ground. However, the embodiments are not limited thereto. According to some embodiments, a vertical deposition process may be performed in the deposition chamber 200 (FIG. 13), in which the first substrate 11 may be moved vertically or tilted at an angle with respect to the ground or horizontal support surface upon which the deposition surface rests. Thus, the supporting frame 121 may be rotated to tilt the first substrate 11 accordingly.

An aperture 122a may be formed in the supporting bar 122 to correspond to the gate 110c. If the first substrate 11 is loaded via the gate 110c, then the first substrate 11 may pass through the aperture 122a of the supporting bar 122 and be positioned on the stage 130.

FIG. 5 illustrates a state in which the supporting frame 121 may be rotated so that an external observer may observe the first substrate 11 through the first transmission unit 110a of the test chamber 110. The first transmission unit 110a may be formed on a side surface of the test chamber 110 so that an external observer may conveniently observe the first substrate 11 in the test chamber 110. The supporting frame 121 may be disposed to correspond to the first transmission unit 110a (FIG. 3), and may be disposed to be parallel, e.g., in alignment, with the first transmission unit 110a, as illustrated in FIG. 5. In this case, the stage 130 on the supporting frame 121 may face the first transmission unit 110a. Thus, an external observer may observe the first substrate 11 placed on the stage 130, through the first transmission unit 110a.

FIG. 6 illustrates a state in which the supporting frame 121 is rotated in such a manner that the optical test unit 160 (FIG. 2) may observe the first substrate 11 through the second transmission unit 110b (FIG. 3) of the test chamber 110. Since both the optical test unit 160 and the second transmission unit 110b may be disposed on the test chamber 110, the supporting frame 121 may be disposed to correspond to the second transmission unit 110b and may be disposed to be parallel, e.g. in alignment with the second transmission unit 110b as illustrated in FIG. 6. In other words, the stage 30 on the supporting frame 121 may face the second transmission unit 110b, and the optical test unit 160 may observe the first substrate 11 on the stage 130 through the second transmission unit 110b.

The probe bar moving unit 140 may be combined with the probe bar 151 and move the probe bar 151 in a direction of, e.g., toward, the stage 130. The probe bar moving unit 140 is moved along guide units 145 (FIG. 2). The probe bar 151 may be moved by the probe bar moving unit 140 to contact the first substrate 11 on the stage 130 and test the plurality of cells 13 on the first substrate 11. The probe bar moving unit 140 may be moved along the guide units 145 to the probe bar supply unit 150 (FIG. 2) so as to obtain the probe bar 151 from the probe bar supply unit 150 or exchange the probe bar 151 previously obtained with another probe bar, as will be described in detail below.

FIG. 7 illustrates a perspective view of the probe bar moving unit 140 included in the testing apparatus 100 of FIG. 1, according to an embodiment. FIG. 8 illustrates a bottom perspective view of the probe bar moving unit 140 of FIG. 7.

Referring to FIGS. 7 and 8, the probe bar moving unit 140 may be combined, i.e., coupled, with the probe bar 151 to move the probe bar 151 in a direction of, e.g., toward, the first substrate 11 placed on the stage 130. The probe bar moving unit 140 may include a connector 144 that is electrically connected to the probe bar 151, and a clamp 146 that engages the probe bar 151. The connector 144 may be electrically connected to an interface unit 153 (FIG. 9) of the probe bar 151. An external signal may be supplied to the probe bar 151 via the connector 144.

The probe bar moving unit 140 may further include an alignment camera 141, a teaching camera 142, and alignment units, namely, first, second, and third alignment units 143a, 143b, and 143c.

The alignment camera 141 may photograph an alignment mark (not shown) formed on the first substrate 11. The first, second, and third alignment units 143a, 143b, and 143c may align the probe bar 151 and the first substrate 11 with each other by moving the probe bar moving unit 140 according to an image captured by the alignment camera 141. The first alignment unit 143a may move the probe bar moving unit 140 in an X-axis direction, the second alignment unit 143b may move the probe bar moving unit 140 in a Y-axis direction, and the third alignment unit 143c may move the probe bar moving unit 140 in a Z-axis direction.

The teaching camera 142 may photograph the plurality of cells 13 on the first substrate 11 (FIG. 1), and provide the optical test unit 160 with location information based on an image captured by photographing the plurality of cells 13. The optical test unit 160 may be moved to a cell 13 that is to be tested from among the plurality of cells 13, based on the location information received from the teaching camera 142, and then test the optical characteristics of the cell 13.

The alignment camera 141 and the teaching camera 142 may be moved in a lengthwise direction of the probe bar moving unit 140.

FIG. 9 illustrates a perspective view of the probe bar supply unit 150 of the testing apparatus 100 of FIG. 1, according to an embodiment. Referring to FIG. 9, the probe bar supply unit 150 may include a plurality of probe bars 151. The probe bar supply unit 150 may provide the probe bar moving unit 140 with one of the plurality of probe bars 151.

The probe bar supply unit 150 may have a hexagonal, pillar shape, and the plurality of probe bars 151 may be respectively disposed on six side surfaces of the probe bar supply unit 150. However, the embodiments are not limited thereto, and the probe bar supply unit 150 may have a polygonal, pillar shape, e.g., a triangular, pillar shape.

The probe bar supply unit 150 may include probe bars 151 of the same or different type. Various types of cells 13 may be tested using only the testing apparatus 100. More specifically, any of various types of the first substrate 11 may be loaded into the testing apparatus 100. In an implementation, referring to FIG. 11, a plurality of rows of cells 13 may be formed on the first substrate 11. Each row of cells 13 extending along a width of the first substrate 11, e.g., Y-direction, may include nine cells, for example. However, the total number of cells 13 that are in each of the rows of cells 13 on the first substrate 11 may vary, and, for example, may be determined according to the size of each of the plurality of cells 13. Also, the plurality of cells 13 on the first substrate 11 may have different circuit constructions. The probe bar supply unit 150 may include various types of probe bars 151 to test any of various types of first substrates 11. The probe bar supply unit 150 may provide the probe bar moving unit 140 with a probe bar 151 matching, e.g., most suited to, the type of the first substrate 11 loaded into the testing apparatus 100 from among the various types of probe bars 151. Thus, according to an embodiment, various types of first substrates 11 may be tested by using only the testing apparatus 100.

The probe bar supply unit 150 may include a rotation motor 154 at a side thereof. The rotation motor 154 may rotate the probe bar supply unit 150. A length of the probe bar supply unit 150 may provide an axis of rotation. When the probe bar moving unit 140 is moved to the probe bar supply unit 150 to exchange one probe bar 151 with another probe bar 151, then the rotation motor 154 may rotate the probe bar supply unit 150 in such a manner that one of the plurality of probe bars 151 that is to be provided to the probe bar moving unit 140 may be easily coupled with the probe bar moving unit 140.

Each of the plurality of probe bars 151 may include a plurality of probe blocks 152 and the interface unit 153.

The plurality of probe blocks 152 may directly contact the plurality of cells 13 on the first substrate 11 to drive the plurality of cells 13 by supplying an external signal to the plurality of cells 13. The plurality of probe blocks 152 may test driving states of the plurality of cells 13 and determine whether circuits of the plurality of cells 13 are down. The total number of probe blocks 152 on each of the plurality of probe bars 151 may be equal to the total number of cells 13 formed on a side of the first substrate 11. In an implementation, nine cells 13 may be formed on the first substrate 11 in an X-axis direction as illustrated in FIG. 11, and nine probe blocks 152 may be disposed on each of the plurality of probe bars 151 to correspond to the nine cells 13 in each row of cells 10 of the first substrate 11, as illustrated in FIG. 9.

The interface unit 153 may be electrically connected to the connector 144 (FIG. 7) of the probe bar moving unit 140. An external signal may be transmitted to the plurality of probe blocks 152 via the connector 144 and the interface unit 153.

The optical test unit 160 may perform an image quality test and an optical property test on the plurality of cells 13 formed on the first substrate 11. For example, when the plurality of probe blocks 152 contact the plurality of cells 13 to drive the plurality of cells 13, the optical test unit 160 may perform the image quality test and the optical property test on the driven cells 13.

FIG. 10 illustrates a perspective view of the optical test unit 160 of the testing apparatus 100 of FIG. 1, according to an embodiment. Referring to FIG. 10, the optical test unit 160 my include an auto vision camera 161, a property tester 162, and first and second linear guides 163 and 164.

The auto vision camera 161 may perform the image quality test on the plurality of cells 13. In other words, the auto vision camera 161 may photograph a driven cell 13 and determine whether an image of the driven cell 13 includes spots.

The property tester 162 may perform the optical property test on the plurality of cells 13. For example, the property tester 162 may measure the brightness and color coordinates of a driven cell 13.

The first linear guide 163 may guide the auto vision camera 161 and the property tester 162 to move in a first direction, e.g., a Y-axis direction. In other words, the auto vision camera 161 and the property tester 162 may be moved along the first linear guide 163 in the first direction, e.g., the Y-axis direction. The second linear guide 164 may guide the first linear guide 163 to move in a second direction, e.g., an X-axis direction, which is perpendicular to the first direction, e.g., the Y-axis direction. For example, the auto vision camera 161 and the property tester 162 on the first linear guide 163 may be moved along the second linear guide 164 in the second direction, e.g., the X-axis direction.

The auto vision camera 161 and the property tester 162 may receive location information of the plurality of cells 13, which is detected by the teaching camera 142 (FIG. 7). The auto vision camera 161 and the property tester 162 may be moved to a desired cell 13 from among the plurality of cells 13.

The optical test unit 160 may be disposed on the test chamber 110, and may observe the plurality of cells 13 via the second transmission unit 110b in the test chamber 110.

FIG. 11 illustrates a perspective view of the first substrate 11 having the plurality of cells 13 on a surface thereof, and the second substrate 12 disposed on the first substrate 11, according to an embodiment. FIG. 12 illustrates a schematic cross-sectional view of one of the plurality of cells 13 of FIG. 11, according to an embodiment. Each of the plurality of cells 13 may include a plurality of organic emission units 310.

Referring to FIG. 12, a plurality of thin film transistors (TFTs) 320 may be disposed on the first substrate 11, and a plurality of organic light-emitting display devices 330 may be disposed on the plurality of TFTs 320, respectively. Each of the plurality of organic light-emitting display devices 330 may include a pixel electrode 331 that is electrically connected to a corresponding TFT 320, an opposite electrode 335 covering an entire surface of the first substrate 11, and an intermediate layer 333 that is disposed between the pixel electrode 331 and the opposite electrode 335 and at least includes an emission layer (not shown).

The plurality of TFTs 320, each including a gate electrode 321, a source and drain electrode 323, a semiconductor layer 327, a gate insulating layer 313, and an interlayer insulating layer 315, are disposed on the first substrate 11. The embodiments are not limited to the plurality of TFTs 320 illustrated in FIG. 12, and any of various types of TFTs, e.g., an organic TFT including the semiconductor layer 327 formed of an organic material and a TFT including the semiconductor layer 327 formed of silicon, may be used. A buffer layer 311, e.g., formed of a silicon oxide or a silicon nitride, may be between the plurality of TFTs 320 and the first substrate 11, if desired.

Each of the plurality of the organic light-emitting display devices 330 may include the intermediate layer 333 disposed between the pixel electrode 331 and the opposite electrode 335 that face each other. The intermediate layer 333 may consist of a plurality of layers including at least one emission layer (not shown). These layers will be described below.

The pixel electrode 331 may function as an anode electrode and the opposite electrode 335 may function as a cathode electrode, or vice versa.

The pixel electrode 331 may be a transparent electrode or a reflective electrode. If the pixel electrode 331 is a transparent electrode, the pixel electrode 331 may be formed of ITO, IZO, ZnO, or In₂O₃. If the pixel electrode 331 is a reflective electrode, the pixel electrode 331 may be formed by forming a reflective layer including at least one of Ag, Mg, Al, Pt, Pd, Au, Ni, Nd, Ir, and Cr, and forming a layer including ITO, IZO, ZnO, or In₂O₃ on the reflective layer.

The opposite electrode 335 may also be a transparent electrode or a reflective electrode. If the opposite electrode 335 is a transparent electrode, the opposite electrode 335 may be formed by forming a layer including at least one of Li, Ca, LiF/Ca, LiF/Al, Al, and Mg to face the intermediate layer 333 between the pixel electrode 331 and the opposite electrode 335, and then forming an auxiliary electrode or a bus electrode line on the layer by using a material for a transparent electrode, e.g., ITO, IZO, ZnO, or In₂O₃. If the opposite electrode 335 is a reflective electrode, the opposite electrode 335 may be formed of at least one of Li, Ca, LiF/Ca, LiF/Al, Al, and Mg.

A pixel defining layer (PDL) 319 may be formed, which covers edges, e.g., exposed surfaces, of the pixel electrode 331 and becomes thicker along outer ends of the pixel electrode 331. The PDL 319 may not only define a light-emitting region but may also increase the distance between the edges, e.g. exposed surfaces, of the pixel electrode 331 and the opposite electrode 335 to prevent an electric field from being concentrated at the edges of the pixel electrode 331. Therefore, a short circuit may be prevented from occurring at the pixel electrode 331 and the opposite electrode 335.

The intermediate layer 333, having the plurality of layers including the at least one emission layer, may be formed between the pixel electrode 331 and the opposite electrode 335. The intermediate layer 333 may be formed of a low or high molecular weight organic material.

If a low-molecular weight organic material is used, then the intermediate layer 333 may have a single or multi-layer structure, including at least one of a hole injection layer (HIL), a hole transport layer (HTL), an emission layer (EML), an electron transport layer (ETL), and an electron injection layer (EIL). Examples of available organic materials may include copper phthalocyanine (CuPc), N,N-di(naphthalene-1-yl)-N,N-diphenyl-benzidine (NPB), tris-8-hydroxyquinoline aluminum (Alq₃), and the like. Such a low-molecular weight organic material may be deposited by vacuum deposition using masks.

If a high-molecular weight organic material is used, then the intermediate layer 333 may have a structure including an HTL and an EML. In this case, Poly(3,4-ethylenedioxythiophene) (PEDOT) may be used as the HTL, and a Poly-Phenylenevinylene (PPV)-based or polyfluorene-based high-molecular weight organic material may be used as the EML.

Each of the plurality of organic light-emitting display devices 330 may be electrically connected to the TFTs 320 therebelow. If a planarization layer 317 is formed covering the plurality of TFTs 320, the plurality of organic light-emitting display devices 330 may be disposed on the planarization layer 317. The pixel electrodes 331 of the plurality of organic light-emitting display devices 330 may be electrically connected to the plurality of TFTs 320, respectively, via contact holes in the planarization layer 317.

The plurality of organic light-emitting display devices 330 on the first substrate 11 may be sealed by the second substrate 12. The second substrate 12 may be formed of any of various materials, e.g., glass or a plastic material.

FIG. 13 illustrates a schematic diagram of a system for manufacturing an organic light-emitting display apparatus, according to an embodiment. Referring to FIGS. 12 and 13, the first substrate 11 may first be loaded into the deposition chamber 200 to form the plurality of TFTs 320 and the plurality of organic light-emitting display devices 330 on the first substrate 11. The first substrate 11 may then pass through the process chamber 300, and be loaded into the bonding device 400. Before the first substrate 11 is bonded with the second substrate 12 (FIG. 11) in the bonding device 400, the first substrate 11 may be loaded into the testing apparatus 100 so that the image quality test and the optical property test may be performed thereon, as described above. Then, the first substrate 11 may be loaded into the bonding device 400 to be bonded with the second substrate 12. Thereafter, the resultant structure may be cut in units of cells to manufacture a panel.

Conventionally, TFTs and organic light-emitting display devices may be formed on a mother substrate, and the mother substrate may be combined with an encapsulating substrate or may be cut in units of cells prior to testing. Such a process may require moving the sealed mother substrate to another device to be tested, and forming an additional test pad on the mother substrate.

However, according to the above embodiments, the testing apparatus 100 may be disposed adjacent to the bonding device 400, connected to the deposition chamber 200. As such, an organic light-emitting display apparatus may be tested and manufactured by continuously performing deposition, testing, and bonding processes, thereby improving the productivity. Also, the testing may be performed before the first substrate 11 (mother substrate) and the second substrate 12 are sealed with each other. Consequently, cells on the mother substrate may be tested by directly making a probe block to contact the cells, and an additional test circuit pattern need not be formed on the mother substrate. Thus, more cells may be formed on the mother substrate. In addition, the cells on the mother substrate may be tested before the encapsulating process is performed, thereby shortening a path of product movement, improving a production rate, and allowing cell defects to be rapidly handled before the encapsulating process is performed, which lowers manufacturing errors.

One or more aspects of the embodiments provide an apparatus for testing an organic light-emitting display apparatus to improve a production rate, and a system for manufacturing an organic light-emitting display apparatus by using the same.

While the embodiments have been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A testing apparatus for testing an organic light-emitting display apparatus, comprising:
a test chamber for retaining a first substrate having a plurality of exposed cells, each cell including an organic emission unit;
a stage in the test chamber, the stage configured to support the first substrate;
a plurality of probe bars, each of the probe bars including a plurality of probe blocks for respectively contacting the exposed plurality of cells of the first substrate to supply an external signal to the exposed plurality of cells;
a probe bar moving unit coupled to the probe bar; and
a probe bar supply unit including the plurality of probe bars,
wherein the probe bar moving unit is configured to move a probe bar to and from the stage and to and from the probe bar supply unit to obtain and unload a probe bar.

2. The testing apparatus of claim 1, wherein the stage is rotatable with respect to an axis normal to a support surface of the stage.

3. The testing apparatus of claim 1, wherein the stage fixes the first substrate in a non-contact manner.

4. The testing apparatus of claim 1, further comprising a support unit disposed in the test chamber, wherein the stage, the probe bar moving unit, and the probe bar supply unit are disposed on a surface of the support unit.

5. The testing apparatus of claim 4, wherein the support unit is rotatable with respect to an axis parallel with the surface of the support unit.

6. The testing apparatus of claim 5, wherein the support unit further includes:
a supporting frame on which the stage is disposed, the probe bar moving unit and the probe bar supply unit being disposed on one surface of the supporting frame; and
supporting legs rotatably connected to opposing sides of the supporting frame.

7. The testing apparatus of claim 1, further comprising an alignment unit for aligning the first substrate and the plurality of probe bars with each other.

8. The testing apparatus of claim 7, wherein the probe bar moving unit includes:
an alignment camera for photographing an alignment mark on the first substrate and the exposed plurality of cells; and
alignment units for moving the probe bar moving unit and aligning at least one of the plurality of probe bars with the first substrate based on an image captured by the alignment camera.

9. The testing apparatus of claim 1, further comprising a guide unit for guiding the moving of the probe bar moving unit.

10. The testing apparatus of claim 1, wherein the probe bar supply unit provides the probe bar moving unit with a probe bar from among the plurality of probe bars, the probe bar being suitable for a type of the plurality of cells.

11. The testing apparatus of claim 10, wherein:
the probe bar supply unit has a polygonal pillar shape, and
the plurality of probe bars are respectively disposed on a plurality of surfaces of the probe bar supply unit.

12. The testing apparatus of claim 11, wherein the probe bar supply unit includes different types of the plurality of probe bars, and provides the probe bar moving unit with a probe bar corresponding to a type of the first substrate loaded into the test chamber.

13. The testing apparatus of claim 1, wherein the probe bar moving unit includes:
a connector electrically connected to the plurality of probe bars; and
a clamp for securing the plurality of probe bars.

14. The testing apparatus of claim 1, further comprising an optical test unit disposed on the test chamber, the optical test unit for testing driving states of the plurality of cells.

15. The testing apparatus of claim 14, wherein the optical test unit includes:
an auto vision camera for performing an image quality test on the plurality of cells;
a property tester for performing an optical property test on the plurality of cells;
a first linear guide for guiding the auto vision camera and the property tester to move in a first direction; and
a second linear guide for guiding the first linear guide to move in a second direction perpendicular to the first direction.

16. The testing apparatus of claim 14, wherein the test chamber includes:
a gate through which the first substrate enters and exits the test chamber;
a first transmission unit for allowing an observer outside the test chamber to observe the first substrate loaded into the test chamber; and
a second transmission unit for allowing the optical test unit to observe the first substrate loaded into the test chamber.

17. The testing apparatus of claim 1, wherein the test chamber is in an N₂ atmosphere.

18. A system for manufacturing an organic light-emitting display apparatus, the system comprising:
a deposition chamber for forming a plurality of cells on a first substrate, each of the plurality of cells including an organic emission unit;
a bonding device for sealing a second substrate on the first substrate to cover the plurality of cells; and
a testing apparatus for testing the plurality of cells on the first substrate before the first substrate and the second substrate are sealed,
wherein the testing apparatus includes
a test chamber in which the first substrate is loaded into or is unloaded from;
a stage in the test chamber, the first substrate being secured to the stage when loaded into the test chamber;
a plurality of probe bars each including a plurality of probe blocks for respectively contacting the plurality of cells to supply an external signal to the plurality of cells;
a probe bar moving unit combined with the probe bar, the probe bar moving unit for moving a probe bar with respect to the stage; and
a probe bar supply unit including the plurality of probe bars,
wherein the probe bar moving unit is moved to the probe bar supply unit to exchange a probe bar with one of the plurality of probe bars.

19. The system of claim 18, wherein the deposition chamber is in a vacuum state, and
the bonding device and the testing apparatus are in an N₂ atmosphere.

20. The system of claim 18, wherein the stage is rotatable with respect to an axis normal to a support surface of the stage.

21. The system of claim 18, wherein the stage fixes the first substrate in a non-contact manner.

22. The system of claim 18, further comprising a support unit disposed in the test chamber, wherein the stage, the probe bar moving unit, and the probe bar supply unit are disposed on a surface of the support unit.

23. The system of claim 22, wherein the support unit is rotatable with respect to an axis parallel with the surface of the support unit.

24. The system of claim 22, wherein the support unit includes:
a supporting frame on which the stage is disposed, the probe bar moving unit and the probe bar supply unit being disposed on one surface of the supporting frame; and
supporting legs rotatably connected to opposing sides of the supporting frame.

25. The system of claim 18, further comprising an alignment unit for aligning the first substrate and the plurality of probe bars with each other.

26. The system of claim 18, wherein the probe bar moving unit includes:
an alignment camera for photographing an alignment mark on the first substrate and the plurality of cells; and
alignment units for moving the probe bar moving and aligning at least one of the plurality of probe bars with the first substrate based on an image captured by the alignment camera.

27. The system of claim 18, further comprising a guide unit for guiding the moving of the probe bar moving unit.

28. The system of claim 18, wherein the probe bar supply unit provides the probe bar moving unit with a probe bar from among the plurality of probe bars, the probe bar being suitable for a type of the plurality of cells.

29. The system of claim 28, wherein:
the probe bar supply unit has a polygonal pillar shape,
the plurality of probe bars are respectively disposed on a plurality of surfaces of the probe bar supply unit.

30. The system of claim 29, wherein the probe bar supply unit includes different types of the plurality of probe bars, and provides the probe bar moving unit with a probe bar corresponding to a type of the first substrate loaded into the test chamber from among the plurality of probe bars.

31. The system of claim 18, wherein the probe bar moving unit includes:
a connector electrically connected to the plurality of probe bars; and
a clamp for fixing the plurality of probe bars.

32. The system of claim 18, further comprising an optical test unit disposed on the test chamber, the optical test unit for testing driving states of the plurality of cells.

33. The system of claim 32, wherein the optical test unit comprises:
an auto vision camera for performing an image quality test on the plurality of cells;
a property tester for performing an optical property test on the plurality of cells;
a first linear guide for guiding the auto vision camera and the property tester to move in a first direction; and
a second linear guide for guiding the first linear guide to move in a second direction perpendicular to the first direction.

34. The system of claim 32, wherein the test chamber includes:
a gate through which the first substrate enters and exits the test chamber;
a first transmission unit for allowing an observer outside the test chamber to observe the first substrate loaded into the test chamber; and
a second transmission unit for allowing the optical test unit to observe the first substrate loaded into the test chamber.

35. The system of claim 18, further comprising a process chamber disposed between the deposition chamber and the bonding device.

36. A method for manufacturing an organic light-emitting display apparatus, comprising:
forming a plurality of cells on a first substrate in a deposition chamber, each cell including an organic emission unit;
passing the first substrate from the deposition chamber through a bonding device;
loading the first substrate into a testing apparatus to test the plurality of cells on the first substrate; and
moving the first substrate from the testing apparatus to the bonding device to seal a second substrate on the first substrate to cover the plurality of cells.
